(19) United States
(12) Patent Application Publication
(10) Pub. No.: US 2024/0240328 A1
(43) Pub. Date: Jul. 18, 2024

(54) WATER ELECTROLYSIS APPARATUS

(71) Applicant: TOYOTA JIDOSHA KABUSHIKI KAISHA, Toyota-shi (JP)

(72) Inventor: Yasuhiro IZAWA, Mishima-shi (JP)

(73) Assignee: TOYOTA JIDOSHA KABUSHIKI KAISHA, Toyota-shi (JP)

(21) Appl. No.: 18/511,234

(22) Filed: Nov. 16, 2023

(30) Foreign Application Priority Data
Jan. 13, 2023 (JP) 2023-003671

(51) Int. Cl. C25B 1/04; C25B 9/23; C25B 9/70; C25B 15/033; C25B 15/08

(52) U.S. Cl. CPC C25B 1/04; C25B 9/23; C25B 9/70; C25B 15/033; C25B 15/083

(57) ABSTRACT

A water electrolysis stack in which a water electrolysis cell is laminated, a water supply side path for supplying water to the water electrolysis stack, and a hydrogen side path for recovering hydrogen generated from the water electrolysis stack are provided, and the water supply side path includes a pump which is a power source for supplying water to the water electrolysis stack, an ion exchanger arranged between the pump and the water electrolysis stack, a bypass which is a path for flowing water from the pump to the water electrolysis stack without passing through the ion exchanger, a valve for adjusting an amount of water flowing to the bypass, and a controller for adjusting a valve.

### CROSS-REFERENCE TO RELATED APPLICATION

This application claims priority to Japanese Patent Application No. 2023-003671 filed on Jan. 13, 2023, incorporated herein by reference in its entirety.

### BACKGROUND

### 1. Technical Field

The present disclosure relates to a water electrolysis apparatus.

### 2. Description of Related Art

In a water electrolysis apparatus that generates hydrogen and oxygen by electrolyzing water, when ions are contained in water supplied to water electrolysis cells in which water electrolysis is performed, deterioration of the water electrolysis cells may be accelerated, and therefore, it is desired to remove these ions.

Japanese Unexamined Patent Application Publication No. 2015-048506 (JP 2015-048506 A) discloses circulating water to remove ions in the system before starting water electrolysis when a water electrolysis apparatus is left for a long period of time, and therefore, ions are removed by an ion exchanger provided downstream of a pump for circulation of pure water supplied to a water electrolysis stack (water electrolysis cells).

### SUMMARY

The technology of JP 2015-048506 A involves problems such as a large load being applied to the pump because of a large pressure loss, and the need for a large ion exchanger and frequent maintenance such as replacement.

In view of the related art, an object of the present disclosure is to provide a water electrolysis apparatus capable of reducing a load on a water supply side path while suppressing deterioration of water electrolysis cells.

As a result of intensive studies, the inventor has found that while it is possible to pass the total amount of water supplied to the water electrolysis stack to an ion exchanger in order to minimize deterioration of the water electrolysis stack, there are many states in which there are few or a few ions in the operation of the water electrolysis apparatus. The inventor considers that passing of water through the ion exchanger even in such a case wastes power for pumping water and increases the size of the ion exchanger, and has solved the above problems by the following specific means.

The present application discloses a water electrolysis apparatus that supplies water to water electrolysis cells and applies a voltage to perform water electrolysis to obtain hydrogen and oxygen, including: a water electrolysis stack in which the water electrolysis cells are stacked; a water supply side path for supplying water to the water electrolysis stack; and a hydrogen side path for recovering hydrogen generated from the water electrolysis stack, in which: the water supply side path includes a pump that is a power source for supplying water to the water electrolysis stack, an ion exchanger disposed between the pump and the water electrolysis stack, a bypass that is a path that allows water from the pump to flow to the water electrolysis stack without passing through the ion exchanger, a valve for adjusting an amount of water that flows through the bypass, and a controller for adjusting the valve; and the controller performs control so as to adjust an opening degree of the valve based on a discharge pressure of the pump or a pressure in a pipe between the pump and the ion exchanger.

The present application discloses a water electrolysis apparatus that supplies water to water electrolysis cells and applies a voltage to perform water electrolysis to obtain hydrogen and oxygen, including: a water electrolysis stack in which the water electrolysis cells are stacked; a water supply side path for supplying water to the water electrolysis stack; and a hydrogen side path for recovering hydrogen generated from the water electrolysis stack, in which: the water supply side path includes a pump that is a power source for supplying water to the water electrolysis stack, an ion exchanger disposed between the pump and the water electrolysis stack, a bypass that is a path that allows water from the pump to flow to the water electrolysis stack without passing through the ion exchanger, a valve for adjusting an amount of water that flows through the bypass, and a controller for adjusting the valve.

In the above water electrolysis apparatus, the controller may acquire a conductivity of the water supplied to the water electrolysis stack in order to obtain the amount of ions, and adjust an opening degree of the valve based on a threshold value of the conductivity.

In the above water electrolysis apparatus, the controller may acquire a difference in a conductivity of water between an upstream side and an downstream side of the ion exchanger in order to obtain the amount of ions, and adjust the opening degree of the valve based on a threshold value of the difference in the conductivity.

According to the present disclosure, it is possible to use a path that does not pass through the ion exchanger and reduce the load on the water supply side path while suppressing deterioration of the water electrolysis cells by removing at least a part of ions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a water electrolysis apparatus;

FIG. 2 is a cross-sectional view illustrating a layer structure of a water electrolysis cell;

FIG. 3 is a conceptual diagram illustrating a configuration of a controller;

FIG. 4 is a diagram for explaining a water supply control S10 according to the first embodiment;

FIG. 5 is a conceptual diagram illustrating a configuration of a water electrolysis apparatus;

FIG. 6 is a view for explaining a water supply control S20 according to a second embodiment; and

FIG. 7 is a diagram for explaining a water supply control S30 according to a third embodiment.

### DETAILED DESCRIPTION OF EMBODIMENTS

### 1. Configuration and Control of Water Electrolysis Apparatus (Form 1)

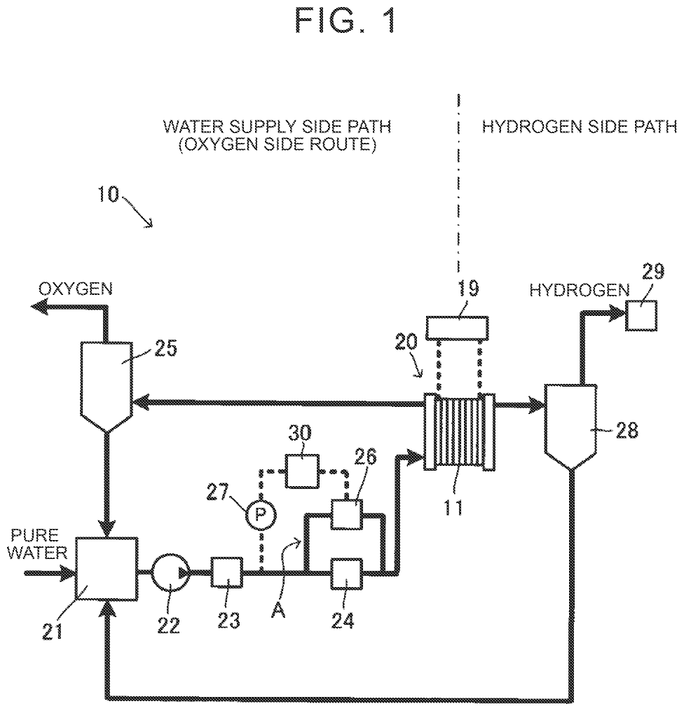

FIG. 1 conceptually illustrates a water electrolysis apparatus 10 according to Embodiment 1. The basic principles and ideas regarding the generation of hydrogen and oxygen by the water electrolysis performed in the water electrolysis apparatus 10 can follow those known in the art.

In the present embodiment, the water electrolysis apparatus 10 has a water electrolysis stack 20 in which a plurality of water electrolysis cells 11 are stacked and both ends thereof are sandwiched between end plates, a water supply side path (oxygen side path) on one side across the water electrolysis stack 20, and a hydrogen side path on the other side.
In the water electrolysis apparatus 10, water is supplied to the water electrolysis cell 11 provided in the water electrolysis stack 20 from the water supply side path, and is energized by the power source 19 to decompose the water into hydrogen and oxygen. The obtained hydrogen is discharged to the hydrogen side path, recovered, and stored.

### 1.1. Water Electrolysis Stack

As described above, the water electrolysis stack 20 is configured such that a plurality of water electrolysis cells 11 are stacked and sandwiched between end plates disposed at both ends thereof.

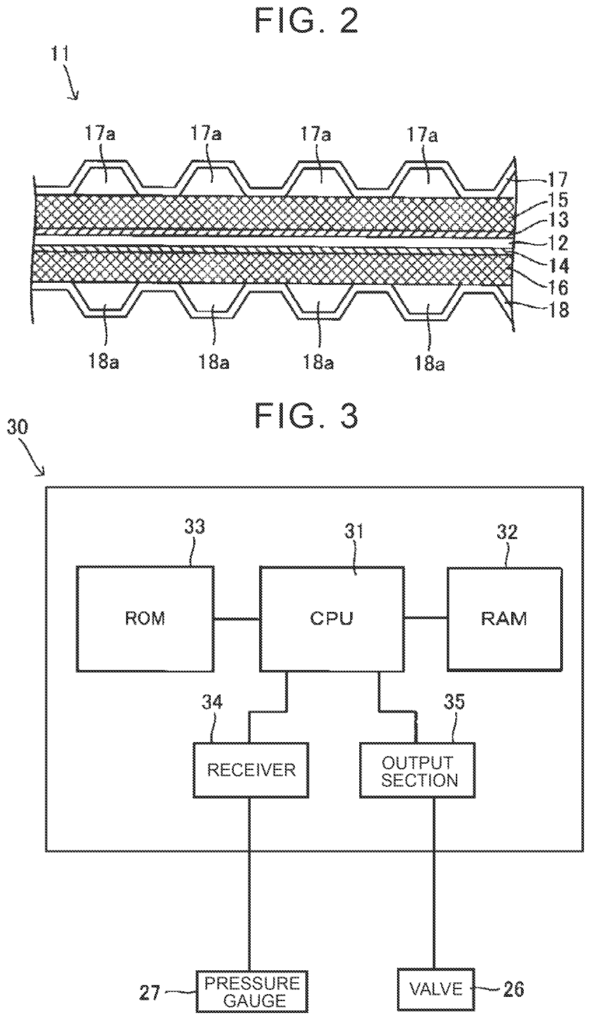

FIG. 2 shows a part of a cross section of a portion where water electrolysis is performed in one water electrolysis cell 11. As can be seen from FIG. 2, the water electrolysis cell 11 has a laminated structure including a plurality of layers. Although the layer structure is known and is not particularly limited, for example, as shown in FIG. 2, in the water electrolysis cell 11, the hydrogen electrode catalyst layer 13, the hydrogen electrode diffusion layer 15, and the hydrogen electrode separator 17 are laminated on one side of the electrolyte membrane 12, and the oxygen electrode catalyst layer 14, the oxygen electrode diffusion layer 16, and the oxygen electrode separator 18 are laminated on the other side of the electrolyte membrane 12.

The hydrogen electrode separator 17 has a corrugated shape in the cross section, and forms a groove-shaped hydrogen electrode flow path 17a with the hydrogen electrode diffusion layer 15, and the hydrogen and the accompanying water flow through the hydrogen electrode flow path 17a and are discharged to the hydrogen side path. On the other hand, the oxygen electrode separator 18 is also corrugated in the cross section and forms a groove-shaped oxygen electrode flow path 18a with the oxygen electrode diffusion layer 16. Water is supplied from the water supply side path to the oxygen electrode flow path 18a, and oxygen and the remaining water are discharged from the oxygen electrode flow path 18a to the water supply side path.

A power source 19 is connected between both electrodes of the water electrolysis stack 20 via a power supply line. When a voltage is applied from the power source 19 to the water electrolysis stack 20, water electrolysis is performed in the water electrolysis cell 11. Here, the power source 19 is as known in the art, and a normal power source used for water electrolysis can be applied.

### 1.2. Water Supply Side Path (Oxygen Side Route)

In the water supply side path (oxygen side path), the city water is passed through an ion exchanger or the like to form pure water and stored in the tank 21, and the pure water is supplied to the water electrolysis stack 20 through the cooler 23 and the ion exchanger 24 by the water pump 22. Oxygen and water leaving the water electrolysis stack 20 are returned to the gas-liquid separator 25 to separate the gas-liquid, and the gas (oxygen) is discharged and the liquid (water) is returned to the tank 21 which is used for water electrolysis again. Each of these members is connected by a pipe, and is configured to allow water and oxygen to flow in a necessary path.

Further, in the present embodiment, a bypass A is provided, which is a path that has pipes branched to the upstream side and the downstream side of the ion exchanger 24 and can supply water to the water electrolysis stack 20 without passing through the ion exchanger 24. The bypass A is provided with a valve 26, and the flow rate is changed according to the opening degree of the valve 26, so that the amount of water flowing through the bypass A can be adjusted.

The type of the valve 26 is not particularly limited, but since the opening degree of the valve 26 is controlled by the controller 30 as will be described later, it is possible to use a regulating valve which is electrically connected to the controller 30 and whose opening degree is operated by a signal.

Further, in the present embodiment, a pressure gauge 27 capable of measuring the pressure in the pipe is disposed between the pump 22 and the ion exchanger 24 in the water supply side path. The pressure gauge 27 can be a known one, as will be described later, from the viewpoint of obtaining a pressure which is one of the information for adjusting the opening degree of the valve 26, electrically connected to the controller 30, it is configured so as to be able to transmit the obtained pressure information to the controller 30.

Furthermore, a controller 30 is provided in the water supply side path. The controller 30 is a controller that controls the water electrolysis apparatus 10 of the present embodiment. More specifically, the present embodiment is a controller that controls the opening degree of the valve 26 based on at least the pressure information from the pressure gauge 27. However, it is not necessary to be a controller only for this purpose, and other functions for controlling the water electrolysis apparatus 10 can be provided.

The embodiment of the controller 30 is not particularly limited, but may typically be configured by a computer. FIG. 3 conceptually illustrates a configuration example of the computer 30 as the controller 30.

The computer 30 includes a Central Processing Unit (CPU) 31 that is a processor, a Random Access Memory (RAM) 32 that functions as a working area, a Read-Only Memory (ROM) 33 as a storage medium, a reception unit 34 that is an interface that receives information regardless of whether it is wired or wireless to the computer 30, and an output unit 35 that is an interface that transmits information regardless of whether it is wired or wireless from the computer 30 to the outside.

A pressure gauge 27 is electrically connected to the reception unit 34, and is configured to receive pressure information by a signal. On the other hand, a valve 26 is electrically connected to the output unit 35 so that the opening degree of the valve 26 can be controlled.

The computer 30 stores a computer program for executing each process for control performed by the water electrolysis apparatus 10 of the present embodiment as a specific command. In the computer 30, a CPU 31, RAM 32 and a ROM 33 as hardware resources and a computer program cooperate with each other. Specifically, CPU 31 executes the computer program recorded in ROM 33 in a RAM 32 functioning as a working area on the basis of pressure information or the like of the pressure gauge 27 acquired via the reception unit 34, thereby realizing a function. The data acquired or generated by CPU 31 is stored in RAM 32. Based on the obtained result, a command is transmitted to the valve 26 via the output unit 35 as necessary.

Details of the control by the water electrolysis apparatus 10 will be described later.

### 1.3. Hydrogen Side Pathway

In the hydrogen side path, as can be seen from FIG. 1, the hydrogen and the accompanying water leaving the water electrolysis stack 20 are recovered in the gas-liquid separator 28, where the gas-liquid is separated, and the gas (hydrogen) is sent to the hydrogen tank 29 via a dehumidifier or the like and stored therein. On the other hand, the water (accompanying water) separated by the gas-liquid separator 28 is returned to the tank 21 of the water supply side path by a pump or the like (not shown). These members are also connected by pipes, and are configured to allow water and hydrogen to flow in a necessary path.

### 1.4. Controller control

As described above, in the water electrolysis apparatus, ions may be contained in the water supplied to the water electrolysis stack. One of the factors is that the metal in the pipe is eluted into the water by the generated hydrogen or the like. Therefore, an ion exchanger is installed to remove ions before supplying water to the water electrolysis stack. On the other hand, as a result of intensive studies, the inventors have found that, although it is one means to pass the total amount of water supplied to the water electrolysis stack to the ion exchanger in order to minimize deterioration of the water electrolysis stack, there are many states in which there are few or few ions in operation of the water electrolysis apparatus. It was considered that passing water through the ion exchanger even in such a state wastes the power of the pump that pumps the water, resulting in an increase in the size of the ion exchanger.

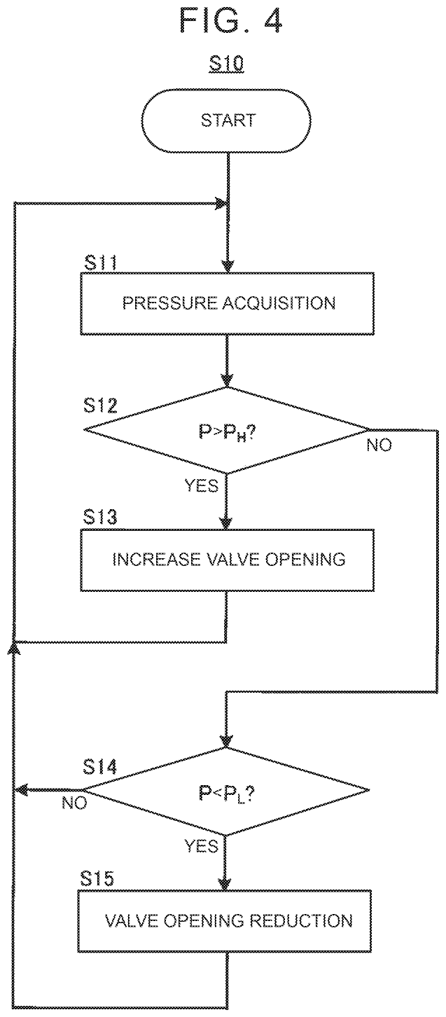

Therefore, in the present embodiment, although it is ideal to remove all ions, in view of the above, considering the relationship between the pump capacity and the capacity of the ion exchanger, it was considered that there is a benefit as a whole water electrolysis apparatus even if water is supplied to the water electrolysis stack by reducing the ion amount by removing a part of the ions. In this embodiment, the controller 30 performs control as follows. FIG. 4 shows the flow of the feed water control S10 by the controller 30.

As shown in FIG. 4, in the present embodiment, the feed water control S10 includes a process S11 and a process S15. This process can be performed by information acquisition, calculation, and command by the controller 30. Each process will be described below.

In the process S11, the controller 30 obtains the pressure P from the pressure gauge 27. This pressure P represents the load on the pump 22.

In the process S12, it is determined whether the pressure P obtained by the process S11 is greater than the prescribed upper limit pressure P_{H}. The prescribed upper limit pressure P_{H} is a pressure value determined based on the upper limit of the discharge capacity of the pump 22. If the prescribed upper limit pressure P_{H} is exceeded, the load of the pump 22 becomes too large, and the possibility of causing a defect increases. This determination is performed by calculation of the controller 30.

If it is determined that P>P_{H} (Yes) in the process S12, the process proceeds to the process S13, and if it is determined that P>P_{H} is not satisfied in the process S12 (No, i.e., P≤P_{H}), the process proceeds to the process S14.

In the process S13, the controller 30 instructs the valve 26 to increase the opening degree of the valve 26 when the process S12 determines Yes. This increases the flow rate of the water flowing to the bypass A to reduce the flow rate of the water flowing to the ion exchanger 24, and it is possible to reduce the pressure loss. Therefore, it is possible to reduce the pressure P. At this time, the method of determining the degree of increase in the opening degree of the valve 26 is not particularly limited, but can be performed as follows, for example.

In Example 1 of the opening degree determination, control is performed by a function or a map obtained in advance. Specifically, an adaptation test is performed in advance, and the relationship between the hydrogen production amount (load current) and the opening degree of the valve 26 with respect to the pressure P is functionalized or mapped, and this is used as a database for calculation by the controller 30.
In the second embodiment of the opening degree determination, the pressure P (the discharge pressure when the discharge pressure of the pump is used as described later) is controlled by feedback control (PI control, PID control) so as to be a target value. That is, the controller 30 performs control so as to change the opening degree of the valve 26 from the comparison with the target value by using the measured value of the pressure P (or the discharge pressure).
After the opening degree of the valve 26 is adjusted in the process S13, the process returns to the process S11.

In the process S14, when No is determined in the process S12, the controller 30 determines whether or not P falls below the specified target pressure P_{L}. The specified target pressure P_{L} is a pressure value determined based on a target pressure during normal operation (during efficient operation) in view of the discharge capacity of the pump 22. By maintaining the operation at the specified target pressure P_{L}, efficient water supply by the pump 22 is performed.

When it is determined that P<P_{L} is determined in the process S14 (Yes), the process proceeds to the process S15, and when it is determined that P<P_{L} is not determined in the process S14 (No, i.e., P≥P_{L}), the process returns to the process S11.

In the process S15, the controller 30 instructs the valve 26 to reduce the opening degree of the valve 26 when Yes is determined in the process S14. As a result, the flow rate of the water flowing to the bypass A can be reduced to increase the flow rate of the water flowing to the ion exchanger 24, so that as much water as possible can be passed through the ion exchanger 24 within an allowable range of the capacity of the pump 22. At this time, the method of determining the degree of the opening degree reduction of the valve 26 is not particularly limited, but Example 1 of the opening degree determination and Example 2 of the opening degree determination described above can be used.

After the opening degree of the valve 26 is adjusted in the process S15, the process returns to the process S11.

### 1.5. Effects, etc.

According to the water electrolysis apparatus 10 of the present embodiment, the frequency of water passing through the ion exchanger can be increased as much as possible by using the power performance of the pump as much as possible. On the other hand, since the pump 22 is suppressed from being in an overload state, it is also possible to avoid a malfunction of the apparatus and to avoid using a pump having a higher capacity than necessary.

In the present embodiment, an example has been described in which the pressure gauge 27 performs the control based on the pressure P in the pipe, but the present disclosure is not limited thereto, and the discharge pressure of the pump 22 may be obtained instead, and the control may be similarly performed using the discharge pressure.

In this embodiment, the magnitude relationship between the pressure P of the pressure gauge 27 and P_{H}, P_{L} is calculated each time to determine whether or not to change the opening degree of the valve 26. However, the present disclosure is not limited thereto, and at least one of the value of the pressure P, the discharge pressure of the pump 22, and the value of the water electrolysis amount (hydrogen generation amount), and the opening degree of the valve 26 may be checked in advance and stored in a database (so-called mapping), and the opening degree of the valve 26 may be obtained based on the database.

### 2. Configuration and Control of Water Electrolysis Apparatus (Form 2)

### 2.1. Configuration of Water Electrolysis Apparatus

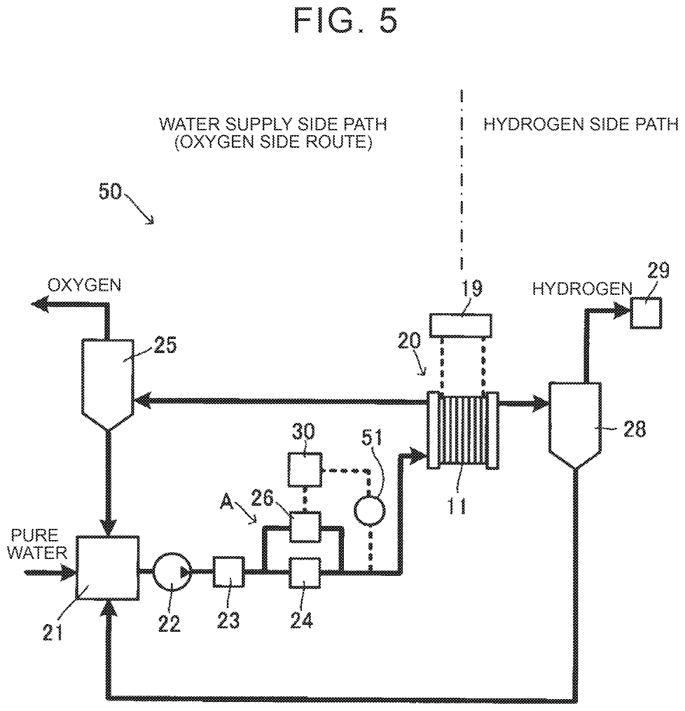

FIG. 5 schematically illustrates a configuration of the water electrolysis apparatus 50 according to Embodiment 2. In the water electrolysis apparatus 50, a conductivity meter 51 is disposed in place of the pressure gauge 27 with respect to the water electrolysis apparatus 10. The other components can be considered in the same manner as the water electrolysis apparatus 10, and thus description thereof will be omitted.

The conductivity meter 51 is a meter that measures the conductivity of water flowing in a pipe between the bypass A and the water electrolysis stack 20 on the downstream side. The resulting conductivity is configured to be able to be transmitted as a signal to the controller 30. Since the conductivity of water is related to the amount of ions in the water, in the present embodiment, the amount of ions can be obtained by measuring the conductivity.

### 2.2. Feed Water Control

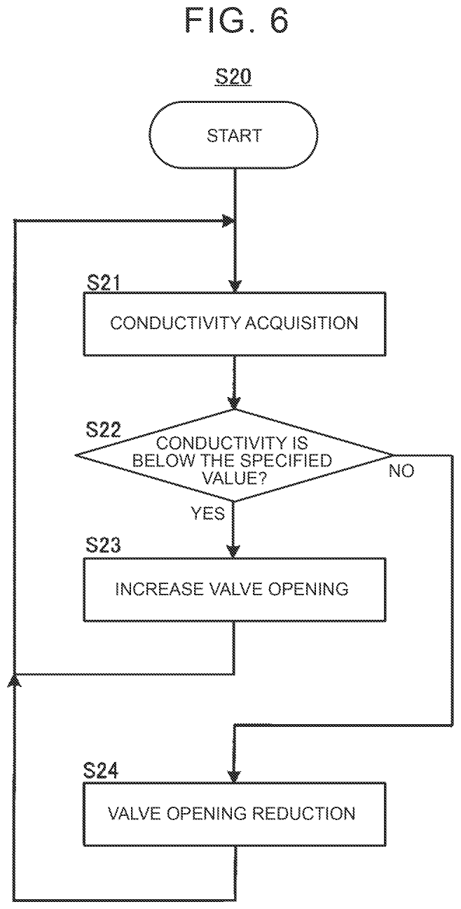

Even in the present embodiment, as described above, it is ideal to remove all ions, but in view of that there are few (small) states of almost no ions, considering the relationship between the pump capacity and the capacity of the ion exchanger, it was considered that there is a profit as a water electrolysis apparatus as a whole even if water is supplied to the water electrolysis stack by reducing the ion amount by removing a part of the ions. In this embodiment, the controller 30 performs control as follows. FIG. 6 shows the flow of the feed water control S20 by the controller 30 of the water electrolysis apparatus 50.

As shown in FIG. 6, in this embodiment, the feed water control S20 includes a process S21 and a process S24. This process can be performed by information acquisition, calculation, and command by the controller 30. Each process will be described below.

In the process S21, the controller 30 acquires the conductivity S from the conductivity meter 51. The conductivity S represents the amount of ions contained in the water supplied to the water electrolysis stack 20.

In the process S22, it is determined whether or not the conductivity S obtained by the process S21 is equal to or less than a specified value. The specified value of the conductivity S is not particularly limited, but is determined in consideration of the influence of ions on the water electrolysis stack, the performance of the ion exchanger, the pump performance, and the like, and specifically, for example, 1 μS/m can be cited. If the conductivity S is greater than the specified value, the effect on the water electrolysis stack may be increased if the large state is continued for a long time.

In the process S22, when it is determined that the conductivity is equal to or less than the specified value (Yes), the process proceeds to the process S23, and in the process S22, the conductivity is not equal to or less than the specified value (No, that is, when it is determined that the conductivity is greater than the specified value), the process proceeds to the process S24.

In the process S23, the controller 30 instructs the valve 26 to increase the opening degree of the valve 26 when the process S22 determines Yes. This increases the flow rate of the water flowing to the bypass A to reduce the flow rate of the water flowing to the ion exchanger 24, and it is possible to reduce the pressure loss. Therefore, it is possible to reduce the load on the pump. In this case, since the conductivity is determined to be equal to or less than the specified value in the process S22, the amount of water that does not pass through the ion exchanger 24 may be increased, so that such control can be performed.

The method of determining the degree of increase in the opening degree of the valve 26 at this time is not particularly limited, but can be performed as follows, for example.
In Example 3 of the opening degree determination, control is performed by a function or a map obtained in advance. Specifically, an adaptation test is performed in advance, and the relationship between the hydrogen production amount (load current) and the opening degree of the valve 26 with respect to the conductivity S is functionalized or mapped, which is used as a database in the calculation by the controller 30.
In the fourth embodiment of the opening degree determination, control is performed by feedback control (PI control, PID control) so as to have a required conductivity S. That is, the controller 30 performs control so as to change the opening degree of the valve 26 from the comparison with the target value using the measured value of the conductivity S.
After the opening degree of the valve 26 is adjusted in the process S23, the process returns to the process S21.

In the process S24, the controller 30 instructs the valve 26 to reduce the opening degree of the valve 26 when the process S22 determines No. Thus, the flow rate of the water flowing to the bypass A can be reduced to increase the flow rate of the water flowing to the ion exchanger 24, it is possible to promote the ion removal by the ion exchanger 24. In this case, since the conductivity S is larger than the specified value in the process S22, such control can be performed because the ions need to be removed. At this time, the method of determining the degree of the opening degree reduction of the valve 26 is not particularly limited, but Example 3 of the opening degree determination and Example 4 of the opening degree determination described above can be used.

After the opening degree of the valve 26 is adjusted in the process S24, the process returns to the process S21.

### 2.3. Effects, etc.

According to the water electrolysis apparatus 50 of the present embodiment, it is possible to suppress the supply of ions to the water electrolysis stack by passing water as much as possible through the ion exchanger while suppressing the burden on the pump and the ion exchanger by control.

In this embodiment, an example has been shown in which it is determined whether to change the opening degree of the valve 26 by calculating the magnitude relationship between the conductivity S of the conductivity meter 51 and the specified value each time, but not limited thereto, the value of the conductivity S, the discharge pressure of the pump 22, and at least one of the values of the water electrolysis amount (hydrogen generation amount), and the opening degree of the valve 26 may be checked in advance and made into a database (so-called mapping), and the opening degree of the valve 26 may be obtained based on the database.

In this embodiment, in order to obtain the amount of ions contained in the supply water using the conductivity meter and its measured value conductivity, the means and the measured value as long as it is possible to obtain the amount of ions contained in the supply water is not particularly limited may be other means.

### 3. Configuration and Control of Water Electrolysis Apparatus (Form 3)

### 3.1. Configuration of Water Electrolysis Apparatus

In the water electrolysis apparatus according to the embodiment 3, a further conductivity meter is also disposed between the upstream side of the bypass A and the pump 22 with respect to the water electrolysis apparatus 50 according to the embodiment 2. Thus, the controller 30 can obtain the difference between the conductivity on the upstream side and the conductivity on the downstream side with the bypass A and the ion exchanger 24 interposed therebetween. The other components can be considered in the same manner as the water electrolysis apparatus 50, and thus description thereof will be omitted.

### 3.2. Feed Water Control

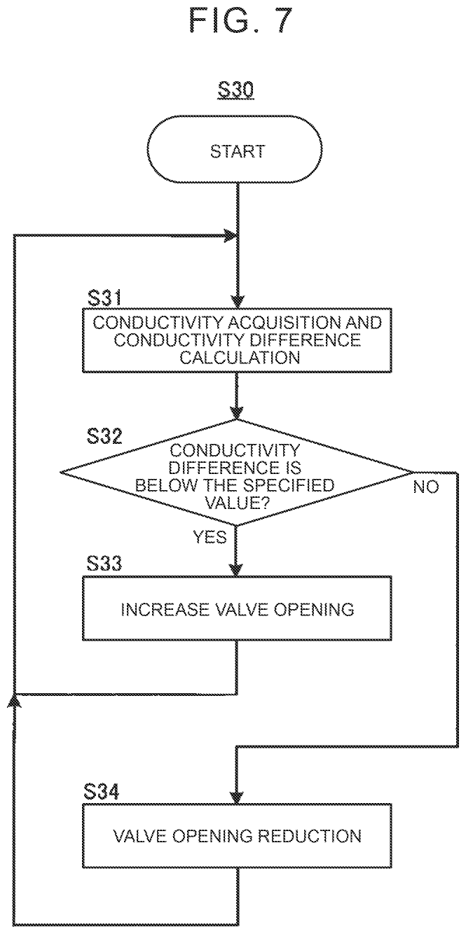

FIG. 7 shows the flow of the feed water control S30 by the controller 30 of the water electrolysis apparatus of the present embodiment. As shown in FIG. 7, in this embodiment, the feed water control S30 includes a process S31 and a process S34. This process can be performed by information acquisition, calculation, and command by the controller 30. Each process will be described below.

In the process S31, the controller 30 obtains the conductivity S from the two conductivity meters, and the controller 30 calculates the conductivity difference between the water sandwiching the bypass A and the ion exchanger 24.

In the process S32, it is determined whether or not the conductivity difference ΔS obtained by the process S31 is equal to or less than a specified value. The specified value of the conductivity difference ΔS is not particularly limited, but is determined in consideration of the influence of ions on the water electrolysis stack, the performance of the ion exchanger, the pump performance, and the like, and specifically, for example, 1 μS/m can be cited. If the conductivity difference ΔS is greater than the specified value, it means that there are many ions to be removed.

When it is determined in the process S32 that the conductivity difference is equal to or less than the specified value (Yes), the process proceeds to the process S33, and when it is determined in the process S32 that the conductivity difference is not equal to or less than the specified value (No, that is, the conductivity difference is larger than the specified value), the process proceeds to the process S34.

In the process S33, the controller 30 instructs the valve 26 to increase the opening degree of the valve 26 when the process S32 determines Yes. This increases the flow rate of the water flowing to the bypass A to reduce the flow rate of the water flowing to the ion exchanger 24, and it is possible to reduce the pressure loss. Therefore, it is possible to reduce the load on the pump. Here, since the conductivity difference in the process S32 is determined to be equal to or less than the specified value, the ion to be removed is small, it is possible to increase the water that does not pass through the ion exchanger, such control is enabled.

At this time, the method of determining the degree of increase in the opening degree of the valve 26 is not particularly limited, but can be performed as follows, for example.
In Example 5 of the opening degree determination, control is performed by a function or a map obtained in advance. Specifically, an adaptation test is performed in advance, and the relationship between the hydrogen production amount (load current) and the opening degree of the valve 26 with respect to the conductivity difference ΔS is functionalized or mapped, which is used as a database in the calculation by the controller 30.
In the sixth embodiment of the opening degree determination, control is performed by feedback control (PI control, PID control) so as to obtain a required conductivity difference ΔS. That is, the controller 30 performs control so as to change the opening degree of the valve 26 from the comparison with the target value by using the measured value ΔS of the conductivity difference.
After the opening degree of the valve 26 is adjusted in the process S33, the process returns to the process S31.

In the process S34, the controller 30 instructs the valve 26 to reduce the opening degree of the valve 26 when No is determined in the process S32. Thus, the flow rate of the water flowing to the bypass A can be reduced to increase the flow rate of the water flowing to the ion exchanger 24, it is possible to promote the ion removal by the ion exchanger 24. In this case, since the conductivity difference ΔS is larger than the specified value in the process S32, such control can be performed because there are many ions to be removed. At this time, the method of determining the degree of opening reduction of the valve 26 is not particularly limited, but the example 5 of the opening degree determination and the example 6 of the opening degree determination described above can be used.

After the opening degree of the valve 26 is adjusted in the process S34, the process returns to the process S31.

### 3.3. Effects, etc.

According to the water electrolysis apparatus of the present embodiment, it is possible to suppress the supply of water to the water electrolysis stack as much as possible through the ion exchanger while suppressing the burden on the pump and the ion exchanger by the control.

In the present embodiment has been shown an example of determining whether to change the opening degree of the valve 26 by calculating the magnitude relationship between the conductivity difference ΔS of the two conductivity meter each time the defined value, not limited to this, the value of the conductivity difference ΔS, the discharge pressure of the pump 22, and at least one of the value of the water electrolysis amount (hydrogen production amount), and the opening degree of the valve 26, it is previously checked in advance and database (so-called mapping), based on the database it may obtain the opening degree of the valve 26.

### 4. Other

Although each of the above-described forms 1 to 3 has been described as a different form, the present disclosure is not limited thereto, and the apparatus and the control may be configured by a combination of the form 1 and the form 2 or a combination of the form 1 and the form 3.

At that time, in the case where the pumping capacity is prioritized as in the case of Form 1, the control can be performed so as to satisfy the conductivity S of Form 2 or the conductivity difference ΔS of Form 3 as much as possible within the range satisfying the condition of Form 1 (although a predetermined threshold value is provided, it is allowed even in a situation where it is not satisfied).
On the other hand, when the reduction of the burden on the water electrolysis stack due to the restriction of the ion amount is prioritized, the control can be performed so that the pressure of the form 1 is satisfied as much as possible within the range satisfying the conditions of the form 2 or the form 3 (although a predetermined threshold is provided, it is allowed even if there is a situation where the pressure is not satisfied).
In addition, in a case where both of the load on the water electrolysis apparatus due to the limitation of the pump capacity and the ion amount are satisfied, the amount of hydrogen produced by the water electrolysis and the flow rate of the water can be changed so as to satisfy both of Forms 1 and 2 or Forms 2 and 3.

What is claimed is:

1. A water electrolysis apparatus that supplies water to water electrolysis cells and applies a voltage to perform water electrolysis to obtain hydrogen and oxygen, comprising:
a water electrolysis stack in which the water electrolysis cells are stacked;
a water supply side path for supplying water to the water electrolysis stack; and
a hydrogen side path for recovering hydrogen generated from the water electrolysis stack, wherein:
the water supply side path includes
a pump that is a power source for supplying water to the water electrolysis stack,
an ion exchanger disposed between the pump and the water electrolysis stack,
a bypass that is a path that allows water from the pump to flow to the water electrolysis stack without passing through the ion exchanger,
a valve for adjusting an amount of water that flows through the bypass, and a controller for adjusting the valve; and
the controller performs control so as to adjust an opening degree of the valve based on a discharge pressure of the pump or a pressure in a pipe between the pump and the ion exchanger.

2. A water electrolysis apparatus that supplies water to water electrolysis cells and applies a voltage to perform water electrolysis to obtain hydrogen and oxygen, comprising:
a water electrolysis stack in which the water electrolysis cells are stacked;
a water supply side path for supplying water to the water electrolysis stack; and
a hydrogen side path for recovering hydrogen generated from the water electrolysis stack, wherein:
the water supply side path includes
a pump that is a power source for supplying water to the water electrolysis stack,
an ion exchanger disposed between the pump and the water electrolysis stack,
a bypass that is a path that allows water from the pump to flow to the water electrolysis stack without passing through the ion exchanger,
a valve for adjusting an amount of water that flows through the bypass, and
a controller for adjusting the valve; and
the controller performs control so as to adjust an opening degree of the valve based on an amount of ions contained in the water supplied to the water electrolysis stack.

3. The water electrolysis apparatus according to claim 2, wherein the controller acquires a conductivity of the water supplied to the water electrolysis stack, and adjusts the opening degree of the valve based on a threshold value of the conductivity.

4. The water electrolysis apparatus according to claim 2, wherein the controller acquires a difference in a conductivity of water between an upstream side and a downstream side of the ion exchanger, and adjusts the opening degree of the valve based on a threshold value of the difference in the conductivity.
